(19) United States
(12) Patent Application Publication
(10) Pub. No.: US 2007/0205611 A1
(43) Pub. Date: Sep. 6, 2007

(54) CLOSURE ELEMENT

(75) Inventors: Uwe Taubert, Weinheim (DE); Werner Kremer, Wiesbaden (DE); Andreas Albrecht, Sulzbach (DE); Dieter Juling, Schmitten (DE)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: Fairchild Fasteners Europe - Camloc GmbH, Kelkheim (DE)

(21) Appl. No.: 11/625,784

(22) Filed: Jan. 22, 2007

(30) Foreign Application Priority Data
Jan. 23, 2006 (DE) 20 2006 001 052.1

(51) Int. Cl. E05C 1/08

(52) U.S. Cl. 292/163

(57) ABSTRACT

A closure element for locking a storage area in a motor vehicle or the like is disclosed. The closure element comprises a frame in which a gripping element is guided so that it may be displaced in one plane, wherein the gripping element is connected to at least two locking bolts which each have at least a partially triangular cross-section, and which are formed by a stop surface aligned at least approximately parallel to the plane, and by an oblique surface.

The invention relates to a closure element, particularly for locking a storage area in a motor vehicle or the like, with a frame in which a gripping element is guided so that it may be displaced in one plane, wherein the gripping element is connected to at least two locking bolts which each have at least a partially triangular cross-section, and which are each formed by a stop surface aligned at least approximately parallel to the plane, and by an oblique surface.

In the trunk of a motor vehicle a so-called storage area is nowadays often provided, forming a flat bottom surface in the trunk. Such a storage area has in most cases a plate which is arranged in the trunk of a vehicle so that it can easily be removed, for example to allow access to a compartment arranged underneath the storage area for a spare wheel, tools or similar objects. In order to close such a compartment securely, and avoid rattling noises during travel, such a storage area must be fixed in the trunk. For this, different fastening elements are known with which a storage area is clamped, engaged or retained by spring force. These systems of prior design are in some cases very expensive to fit and/or difficult for a user to handle. In some sealing systems of prior design it is also found to be disadvantageous if the storage area does not close by itself, i.e. by the force of gravity, and is automatically locked in this position.

Storage areas which can be completely removed from the trunk, and can be reversed, are now frequently used. Here, for example, one side is made flat and is provided with decorative material, so that this side faces the interior of the trunk during normal use. The opposite side may be designed, for example, so that it incorporates a loading trough or additional means of fixing not prone to soiling. For example, this side may be coated with plastic or rubber. This side is therefore often facing the interior of the trunk when soiled/dirty objects are to be transported. Such storage areas that can be used on both sides impose heavy demands on their closure elements because the storage areas have to be securely fixed in both positions.

One object of this invention is therefore to provide a element which is suitable for the detachable locking of a storage area that can be used on both sides. Moreover, the closure element should be able to be produced as simply and at as low a cost as possible, as well as being as user-friendly as possible.

This object is essentially achieved with a closure element of the type already mentioned in that the oblique surfaces of two adjacent locking bolts run onto the stop surfaces connected to them in opposite directions. Two locking bolts or bolting noses acting in opposite directions are therefore formed on the closure element according to the invention. At least one locking bolt is therefore provided whose oblique surface runs from the top of the frame to the tip of a stop surface, whilst the oblique surface of at least one second bolt runs from a second surface of the frame opposing the first surface obliquely onto a further stop surface. Here both oblique surfaces enable the bolts to be pushed back when they fall onto one edge or are pushed against one edge due to gravity. Here the opposing oblique surfaces ensure that this system operates regardless of which side of the frame forms a lower side and which an upper side. When the bolts pushed back in this way reach a suitably large recess they can be pushed forward again so that the stop surfaces are anchored behind a wall of the recess, thereby locking the closure element in the recess. Since the two stop surfaces also point in different directions, this locking is possible regardless of which side of the frame forms the upper side and which the lower side. The closure element according to the invention is therefore particularly suitable for use with a storage area that can be used on both sides.

According to a preferred embodiment of the invention at least two bolts that are mirror symmetrical to the plane and are offset in relation to each other along the plane are arranged on the gripping element. When the plate-type storage area or similar, on which the closure element according to the invention may be secured, is turned, one of the bolts always performs the locking function. The stop surfaces and/or the oblique surfaces of the bolts or locking noses need not in this case be closed surfaces but may be formed by bridges or the like.

To enable the closure element to be opened provision is made, according to the invention, for the bolts to be rigidly connected, and, in particular, to be integral with the gripping element. By pulling the gripping element back into the frame the bolts projecting from the frame are also retracted into the frame leaving open a storage area. If the bolts are designed so that they are mounted integrally in the gripping element, not only is a good connection achieved between the bolts and the gripping element, but the number of components of the closure element is reduced. This facilitates assembly.

An elastic element, specifically a compression spring, is provided between the gripping element and the frame, wherein the elastic element can initially tension the gripping element against a stop in the frame. The gripping element can therefore be displaced backwards and forwards in the frame between two stops, in particular, wherein the gripping element is loaded by the spring into a position in which the bolts project from the frame. However, the bolts can be pushed back into the frame together with the gripping element against the force of the compression spring, for example, until the bolts no longer project from the frame.

The number of components required to manufacture a closure element according to the invention can be further reduced when the elastic element is a spring formed integrally with the frame or the gripping element. Consequently the closure element can be manufactured solely from a frame and an attached gripping element which can be displaced, on which element the bolts are provided. This two-part construction allows a particularly simple assembly where only two different components need be retained. In this case both the frame and the gripping element can be produced with the bolts and a plastic spring provided on the frame or gripping element.

In order to mount the gripping element so that it may be displaced in the frame and protect it from falling out, at least one guide, for example a groove or recess, can be provided in the frame, and at least one element can be guided in the guide, a stop hook for example, may be provided on the gripping element. In this case stop hooks can perform the functions both of guiding the gripping element in the frame by engaging in suitable recesses and of preventing the gripping element in the frame from falling out after assembly.

According to one embodiment the frame can be designed in the form of a housing and provided with a shaft for receiving the gripping element. Here the shaft is opened from the top and bottom of the frame, e.g. by means of a through recess, in order to release the gripping element for actuation. In this case the gripping element itself can either be closed and provided with handles or the like for actuation, or alternatively it is also possible to provide a recess in the gripping element itself, so that the frame and gripping element have a common through opening. A user is therefore able to reach through the opening in the frame and through the gripping element to actuate it so that the gripping element can be retracted in the frame. At the same time this design enables a storage area to be lifted extremely easily by reaching into the through opening of the frame and gripping element.

Stop, clamping and/or bolt elements are preferably provided on the outside of the frame with which the frame can be secured, for example, in a plate-shaped component such as a storage area or the like. Alternatively, or in addition to this, fastening holes may also be provided in the frame so that the frame can be securely screwed into a plate.

To allow secure retention of the closure element in a plate, the frame has a flanged edge on its upper and lower side, the plate-like component being received between these flanged edges.

The invention also relates to a floor element, in particular a storage area for a vehicle or for an aircraft, with a plate-shaped component on which a closure element of the type mentioned above is secured. Here the two opposing surfaces of the plate-type component can be provided with different materials, for example a plastic or rubber surface on the one side, and a fabric surface on the other side.

Moreover, the invention relates to a trunk with such a floor element and a frame in which are arranged at least two mirror-symmetrical openings offset in relation to each other for detachable locking of the floor element.

Further advantages and possible applications of the invention are also evident from the following description of one embodiment and the drawing. Here all the characteristics described and/or pictorially represented individually constitute the object of the invention, regardless of their summary description in the claims or their references.

Diagrammatically

FIG. 1 shows a perspective view of a closure element, according to the invention, in its locked position,

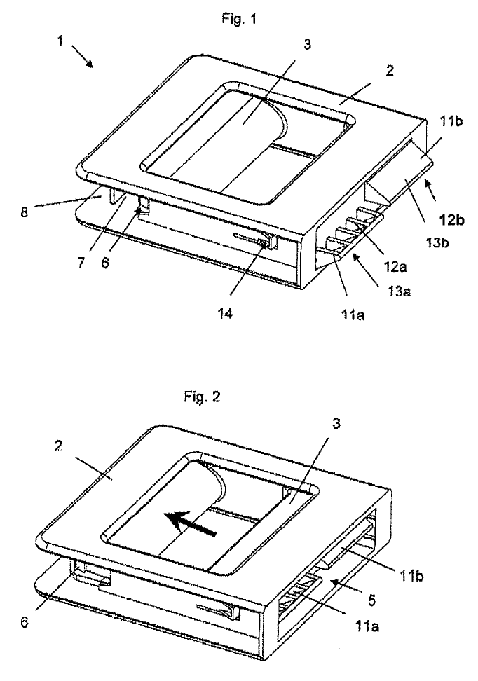

FIG. 2 shows a perspective view of the closure element, according to FIG. 1, in its open position,

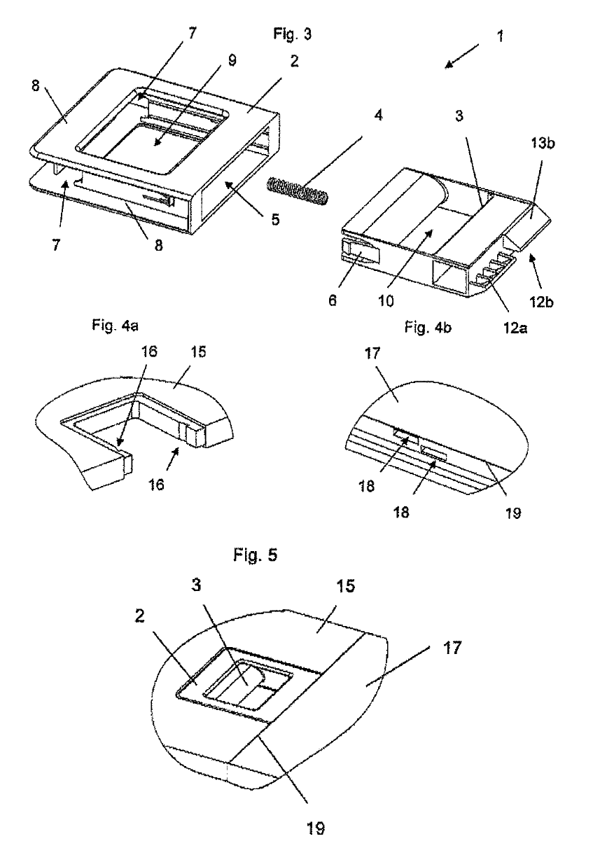

FIG. 3 shows an exploded view of the closure element according to the invention,

FIG. 4a shows a section from a storage area for receiving a closure element according to the invention,

FIG. 4b shows sectionally a wall of the trunk floor, and

FIG. 5 shows sectionally a trunk floor with a closure element according to the invention.

Closure element 1 shown in the figures is formed by an integral housing-like frame 2, an integral gripping element 3, and a compression spring 4, as evident, in particular, from the view in FIG. 3. Here a shaft 5 is provided in frame 2, into which shaft gripping element 3 can be inserted. Gripping element 3 is in this case provided with stop hooks 6, which are able to engage in recesses 7 in frame 2 when gripping element 3 is inserted in frame 2. Gripping element 3 is therefore prevented from falling out of frame 2 and is guided into frame 2 so that it may be displaced. Here compression spring 4 loads gripping element 3 into its advanced position in which stop hooks 6 stop on one wall of recesses 7.

The top and bottom of the housing-like frame 2 are each provided with a flanged edge 8 which projects laterally and to the rear through the shaft for receiving gripping element 3. Furthermore two openings 9 are provided in the top and bottom of the housing like frame, which openings provide access to shaft 5 and gripping element 3 received in it. Gripping element 3 is also provided, in the design shown, with a through opening 10 which at least partially overlaps openings 9 in frame 2. As indicated by the arrow in FIG. 2, it is possible to reach through openings 9 and 10 with one hand and to pull back gripping element 3 against the force of the spring in frame 2.

On the side facing away from spring 4, gripping element 3 has two bolts 11a and 11b. Here bolts 11a and 11b project forward from frame 2 in the bolting position shown in FIG. 1. On the other hand, both bolts 11a and 11b are retracted fully into frame 2 in the open position shown in FIG. 2. Both bolts are designed integrally with the gripping element and are each provided, in the design shown, with a stop face 12a and 12b formed by bridges. Here stop surfaces 12a and 12b extend in parallel planes, which also run parallel with the plane in which gripping element 3 can be displaced in frame 2. Alternatively, the two stop surfaces may also lie in a common plane. Bolts 11a and 11b are also formed by an oblique surface 13a and 13b respectively, so that the bolts form a triangular cross-section. The two bolts 11a and 11b differ in that oblique surface 13a in FIG. 1 runs from the bottom obliquely onto to the front edge of stop surface 12a, whilst oblique surface 13b of bolt 11b runs from the top obliquely onto the front edge of stop surface 12b. Both bolts 11a and 11b are consequently mirror symmetrical to the plane in which gripping element 3 is displaceable and are arranged offset in relation to each other along this plane. This means that when closure element 1 is rotated 180° about an axis parallel with the direction of displacement of gripping element in frame 2, bolt 11a would assume the exact position of bolt 11b, and vice versa.

As can be seen from FIG. 1, a stop nose 14 is formed on the outside of frame 2 between flanged edges 8. A stop nose 14, not shown in the figures, is also provided on the opposite side. These stop noses 14 enable closure element 1 to be secured extremely easily in a storage area 15, represented diagrammatically in FIG. 4a, if it has a suitable stop geometry, as indicated by reference numbers 16. Closure element 1 may here be pushed onto storage area 15, in which case flanged edges 8 surround the storage area in certain regions. Here stop noses 14 engage behind the recesses of stop geometry 16 and lock the closure element in storage area 15. Alternatively or in addition to this, it is also possible to provide through holes in flanged edge 8, so that frame 2 is securely screwed to storage area 5.

FIG. 4b shows in a sectional view a trunk wall 17 which has a locking contour formed by two openings 18. Here both openings 18 have essentially the same size and shape. However, they are arranged offset in relation to each other both vertically and laterally. Here the locking contour formed by openings 18 is adapted to the position and size of bolts 11a and 11b so that the bolts can be inserted in openings 18 by the force of spring 4. Regardless of which of the two sides of frame 2 represents the upper side and which the lower side, one of stop surfaces 12a or 12b always lies in this locking position on a wall of one of openings 18 so that closure element 1 and a storage area 15, connected to it, are fixed on trunk wall 17, as shown in FIG. 5.

Because of oblique surfaces 13, 13b it is also possible to allow storage area 15 to close on its own, i.e. by gravity only, wherein the oblique surface that first comes into contact with upper edge 19 of trunk wall 17 causes bolts 11a and 11b to move back together with gripping element 3 against the force of spring 4, so that closure element 1 is able to pass edge 19. Not until the two bolts 11a and 11b oppose openings 18 is gripping element 3 pushed forward out of frame 2 by the force of spring 4, so that bolts 11a and 11b engage to lock in openings 18. For opening storage area 15, only gripping element 3, which is revealed through openings 9, are retracted against the force of spring 4.

### LIST OF REFERENCES

1 Closure element
2 Frame/housing
3 Gripping element
4 Compression spring
5 Shaft
6 Stop hook
7 Recess
8 Flanged edge
9 Opening
10 Opening
11a, 11b Locking Bolts
12a, 12b Stop surface
13a, 13b Oblique surface
14 Stop nose
15 Storage area
16 Stop geometry/recess
17 Trunk wall
18 Opening/locking contour
19 Edge

1. A closure element, in particular for locking a storage area in a motor vehicle or the like, with a frame in which a gripping element is guided in the same plane so that it may be displaced, wherein the gripping element is connected to at least two locking bolts, each of which has a triangular cross-section, at least in sections, and each of which is formed by a stop surface aligned at least approximately parallel with the plane, and by an oblique surface, wherein the oblique surfaces of two adjacent bolts run in opposite directions onto the stop surfaces connected to them.

2. The closure element according to claim 1, wherein at least two bolts are mirror symmetrical to the plane and offset relative to each other along the plane.

3. The closure element according to Class 1 or 2, wherein the bolts are rigidly, e.g. integrally, connected to the gripping element.

4. The closure element according to claim 1 wherein an elastic element, in particular a compression spring (4), is provided between the gripping element and the frame, which spring initially tensions the gripping element against a stop in the frame.

5. The closure element according to claim 4, wherein the elastic element is a spring designed integrally with the frame or the gripping element.

6. The closure element according to claim 1 wherein the frame has at least one guide, in particular a groove or recess, and in that the gripping element has at least one element guided in at least one of the guides, in particular a stop hook.

7. The closure element according to claim 1 wherein a shaft is formed in the frame (2) for receiving the gripping element (3), wherein an opening (9), in particular a through opening, is provided in the shaft (5) for actuating the gripping element (3).

8. The closure element according to claim 1 wherein stop, clamping and/or bolting elements and/or fastening holes are provided for connecting the closure element to a component, in particular a plate-type component.

9. A floor element, in particular a storage area for a vehicle or aircraft, with a plate-type component, to which a closure element is secured according to claim 1 wherein the two surfaces of the plate-type component are provided with different materials, in particular with a plastic or rubber surface and with a fabric surface.

10. A trunk with a floor element according to claim 9 and with a frame, in which at least two mirror symmetrical openings, offset in relation to each other, are arranged for the detachable locking of the floor element.
